(19) United States
(12) Patent Application Publication
(10) Pub. No.: US 2013/0233958 A1
(43) Pub. Date: Sep. 12, 2013

(54) WEBBING RETRACTOR

(71) Applicant: KABUSHIKI KAISHA TOKAI-RIKA-DENKI-SEISAKUSHO, Aichi-ken (JP)

(72) Inventors: Wataru YANAGAWA, Aichi-ken (JP); Masaru UKITA, Aichi-ken (JP); Yoshiaki MAEKUBO, Aichi-ken (JP)

(73) Assignee: KABUSHIKI KAISHA TOKAI-RIKA-DENKI-SEISAKUSHO, Aichi-ken (JP)

(21) Appl. No.: 13/784,904

(22) Filed: Mar. 5, 2013

(30) Foreign Application Priority Data
Mar. 8, 2012 (JP) 2012-052053

(51) Int. Cl. B60R 22/34

(52) U.S. Cl. CPC B60R 22/3413
USPC 242/379.1

(57) ABSTRACT

In a webbing retractor, in a state where a second anchored portion of a sub torsion shaft is connected to a frame via a rotation impeding mechanism, when a spool is pulled by excessive tension that is applied to a webbing, there is a tendency for the spool to tilt with respect to a sleeve that is supported at the frame via the rotation impeding mechanism. In this case, a distance between a second energy absorbing portion of the sub torsion shaft and an inner peripheral surface of an insert-through hole changes. A change in the distance becomes large at an opening side of the insert-through hole, but an inner diameter of the insert-through hole is enlarged at the opening side. Due thereto, it can be made such that the second energy absorbing portion does not interfere with the inner peripheral surface of the insert-through hole.

### CROSS-REFERENCE TO RELATED APPLICATION

This application claims priority under 35 USC 119 from Japanese Patent Application No. 2012-052053 filed Mar. 8, 2012, the disclosure of which is incorporated by reference herein.

### BACKGROUND OF THE INVENTION

1. Field of the Invention

The present invention relates to a webbing retractor that a seatbelt device for a vehicle or the like is provided with.

2. Related Art

In the retractor for a seatbelt that is disclosed in Japanese Patent Application Laid-Open (JP-A) No. 11-105671, a tubular retainer is mounted to one end portion of a bobbin, and the bobbin is supported so as to be able to rotate at a side plate of a retractor base via the retainer. One end side of the retainer projects-out further toward the outer side than the side plate of the retractor base, and one end portion of a torsion bar is anchored on the one end portion of the retainer. One end side of a torsionally deforming portion, that is provided at the intermediate portion of the torsion bar, is inserted through (inserted with play in) the inner side of the retainer, and the other end portion of the torsion bar is anchored at a locking base at the other end side of the bobbin. When this locking base is engaged with the retractor base by an emergency locking unit at the time of an emergency of the vehicle, rotation of the one end portion of the torsion bar is impeded. In this state, when the tension that is applied from the passenger to the webbing exceeds a predetermined value, the torsionally deforming portion of the torsion bar torsionally deforms, and due thereto, the bobbin rotates in the webbing pull-out direction, and a predetermined amount of the webbing is pulled out. Due thereto, the load on the passenger is reduced.

The length of the torsion bar being longer, the number of times of torsion of the above-described torsion bar increases. Therefore, in the above-described retractor for a seatbelt, the length of the torsion bar is made to be long by making the one end side of the torsion bar project-out further toward the outer side than the side plate of the retractor base.

In the above-described retractor for a seatbelt (webbing take-up device), when the bobbin (take-up shaft) is pulled by excessive tension that is applied to the webbing at the time of operating of the emergency locking unit, there is the possibility that the take-up shaft would tilt with respect to the retainer (torsion bar anchoring member) that is supported at the retractor base (frame). As a result, there is the possibility that the inner peripheral surface of the torsion bar anchoring member and the torsionally deforming portion of the torsion bar would interfere with one another.

### SUMMARY OF THE INVENTION

The present invention is made in view of the above-described problem, and the present invention is to provide a webbing retractor that, even when a take-up shaft tilts with respect to a torsion bar anchoring member through which a torsionally deforming portion of a torsion bar is inserted, can make it such that the torsionally deforming portion does not interfere with the inner peripheral surface of the torsion bar anchoring member.

In order to overcome the above-described problem, a webbing retractor relating to an invention of a first aspect has: a take-up shaft that is rotatably supported at a frame, and that takes-up a webbing for restraining a passenger; a torsion bar, one end portion of which is connected to the take-up shaft so as to be unable to rotate relative to the take-up shaft, the torsion bar comprising a torsionally deforming portion, that is provided at an intermediate portion of the torsion bar, torsionally deforming when tension of a set value or more is applied to the webbing in a state in which another end portion of the torsion bar is connected to the frame via a rotation impeding mechanism; and a torsion bar anchoring member that is rotatably supported at the frame, and that includes an anchor portion at which the one end portion or the other end portion of the torsion bar is anchored, and an insert-through hole including an opening that is open at a side of the torsion bar anchoring member opposite a side at which the anchor portion is provided, through which the torsionally deforming portion is inserted in a state of not contacting an inner side of the insert-through hole, an inner diameter of the insert-through hole being enlarged at the opening side.

Note that “connect” recited in the first aspect includes a case of being connected directly and a case of being connected indirectly.

Similarly, “support” recited in the first aspect includes a case of being supported directly and a case of being supported indirectly.

Further, the invention of the first aspect includes a structure in which the one end portion of the torsion bar, that is anchored at the anchor portion of the torsion bar anchoring member, is connected via the torsion bar anchoring member to the take-up shaft so as to be unable to rotate relative thereto.

In the invention of the first aspect, at the time of rapid deceleration of the vehicle for example, the other end portion of the torsion bar is connected to the frame via the rotation impeding mechanism. In this state, when tension of the set value or more is applied from the passenger to the webbing, the intermediate portion (the torsionally deforming portion) of the torsion bar, whose one end portion is connected to the take-up shaft so as to be unable to rotate relative thereto, torsionally deforms, and, due thereto, the take-up shaft rotates in the webbing pull-out direction, and a predetermined amount of the webbing is pulled-out. Due thereto, the load on the passenger is decreased.

Here, in the present invention, in the state in which the other end portion of the torsion bar is connected to the frame as described above, when the take-up shaft is pulled by excessive tension applied to the webbing, there is the possibility that the take-up shaft will tilt with respect to the torsion bar anchoring member that is supported at the frame. The one end portion or the other end portion of the torsion bar is anchored at the anchor portion of this torsion bar anchoring member, and the torsionally deforming portion of the torsion bar is inserted-through the inner side of the insert-through hole of the torsion bar anchoring member in a non-contacting state. Therefore, due to the take-up shaft tilting with respect to the torsion bar anchoring member, the distance between the torsionally deforming portion of the torsion bar and the inner peripheral surface of the insert-through hole changes. This change in distance becomes large at the side of the torsion bar anchoring member that is opposite the anchor portion is provided, i.e., at the opening side of the insert-through hole. However, the inner diameter of the insert-through hole is enlarged at the opening side. Due thereto, it can be made such that the torsionally deforming portion of the torsion bar does not interfere with the inner peripheral surface of the insert-through hole of the torsion bar anchoring member.

In a webbing retractor relating to an invention of a second aspect, in the first aspect, the inner diameter of the insert-through hole is enlarged in a tapered shape toward the opening.

In the invention of the second aspect, the inner diameter of the insert-through hole of the torsion bar anchoring member is enlarged in a tapered shaped toward the opening of the insert-through hole, i.e., toward the side at which the change in the distance between the torsionally deforming portion of the torsion bar and the inner peripheral surface of the insert-through hole, at the time when the take-up shaft tilts with respect to the torsion bar anchoring member, becomes large. Due thereto, the rigidity of the torsion bar anchoring member can be ensured while interference between the torsionally deforming portion of the torsion bar and the inner peripheral surface of the insert-through hole is prevented well.

In a webbing retractor relating to an invention of a third aspect, in the first aspect or the second aspect, an outer diameter of the torsion bar anchoring member is enlarged at the opening side.

In the invention of the third aspect, the outer diameter of the torsion bar anchoring member is enlarged at the opening side of the insert-through hole, i.e., at the side where the inner diameter of the insert-through hole is enlarged (in a tapered shape). Due thereto, the rigidity of the torsion bar anchoring member, at the side at which the inner diameter of the insert-through hole is enlarged, can be improved.

In a webbing retractor relating to an invention of a fourth aspect, in any one of the first through third aspects, the torsion bar anchoring member is a structural member of the rotation impeding mechanism, and is mounted to the take-up shaft so as to be able to rotate relative to the take-up shaft, and the other end portion of the torsion bar is anchored at the anchor portion, and the rotation impeding mechanism is structured so as to, by connecting the torsion bar anchoring member and the frame, impede rotation of the torsion bar anchoring member in a webbing pull-out direction.

In the invention of the fourth aspect, due to the torsion bar anchoring member being connected to the frame at the time of rapid deceleration of the vehicle for example, rotation of the torsion bar anchoring member in the webbing pull-out direction is impeded. As a result, rotation in the webbing pull-out direction of the other end portion of the torsion bar, that is anchored to the anchor portion of the torsion bar anchoring member, is impeded. In this state, when tension of the set value or more is applied from the passenger to the webbing, the intermediate portion (the torsionally deforming portion) of the torsion bar, whose one end portion is connected to the take-up shaft so as to be unable to rotate relative thereto, torsionally deforms, and, due thereto, the take-up shaft rotates in the webbing pull-out direction, and a predetermined amount of the webbing is pulled-out. Due thereto, the load on the passenger is decreased.

It is possible in the third aspect that a length along an axial direction of a portion of the torsion bar anchoring member, at which the outer diameter is enlarged at the opening side, is substantially the same as a length along the axial direction of a portion of the torsion bar anchoring member, at which the inner diameter of the insert-through hole is enlarged at the opening side.

It is possible in the fourth aspect that a length along an axial direction of a portion of the torsion bar anchoring member, at which the outer diameter is enlarged at the opening side, is substantially the same as a length along the axial direction of a portion of the torsion bar anchoring member, at which the inner diameter of the insert-through hole is enlarged in the tapered shape toward the opening.

It is possible in the third aspect that a length along an axial direction of a portion of the torsion bar anchoring member, which portion is fit with the take-up shaft so as to rotate freely, is substantially the same as a length along the axial direction of a portion of the torsion bar anchoring member, at which the inner diameter of the insert-through hole is enlarged at the opening side.

It is possible in the first aspect that the other end portion of the torsion bar is anchored at the anchor portion of the torsion bar anchoring member, and the inner diameter of the insert-through hole is enlarged between the opening and the anchor portion. Further, it is possible that the inner diameter of the insert-through hole is enlarged in a tapered shape toward the opening from the anchor portion.

As described above, in the webbing retractor relating to the present invention, it can be made such that the torsionally deforming portion does not interfere with the inner peripheral surface of the torsion bar anchoring member, even when the take-up shaft tilts with respect to the torsion bar anchoring member through which the torsionally deforming portion of the torsion bar is inserted.

### BRIEF DESCRIPTION OF THE DRAWINGS

Embodiments of the invention will be described in detail with reference to the following figures, wherein:

FIG. 1 is an exploded perspective view showing the structures of main portions of a webbing retractor relating to a first embodiment of the present invention;

FIG. 2 is an exploded perspective view showing the structure of a clutch mechanism that is a structural member of the webbing retractor;

FIG. 3 is an exploded perspective view showing the structure of a switching mechanism that is a structural member of the webbing retractor;

FIG. 4 is a drawing in which the clutch mechanism is viewed from a side opposite a spool;

FIG. 5A is a drawing showing a state in which clutch plates of the clutch mechanism start to rotate toward a lock ring side, and FIG. 5B is a drawing showing a state in which the clutch plates are meshed with the lock ring;

FIG. 6A is a cross-sectional view showing the structures of the spool, a sub torsion shaft, a sleeve and a screw of the webbing retractor, and FIG. 6B is a cross-sectional view showing a state in which the spool is tilted with respect to the sleeve;

FIG. 7 is a perspective view showing the structure of the sleeve; and

FIG. 8A is a cross-sectional view showing the structures of a spool, a sub torsion shaft, a sleeve and a screw of a webbing retractor relating to a second embodiment of the present invention, and FIG. 8B is a cross-sectional view showing a state in which the spool is tilted with respect to the sleeve.

### DETAILED DESCRIPTION OF THE INVENTION

### First Embodiment

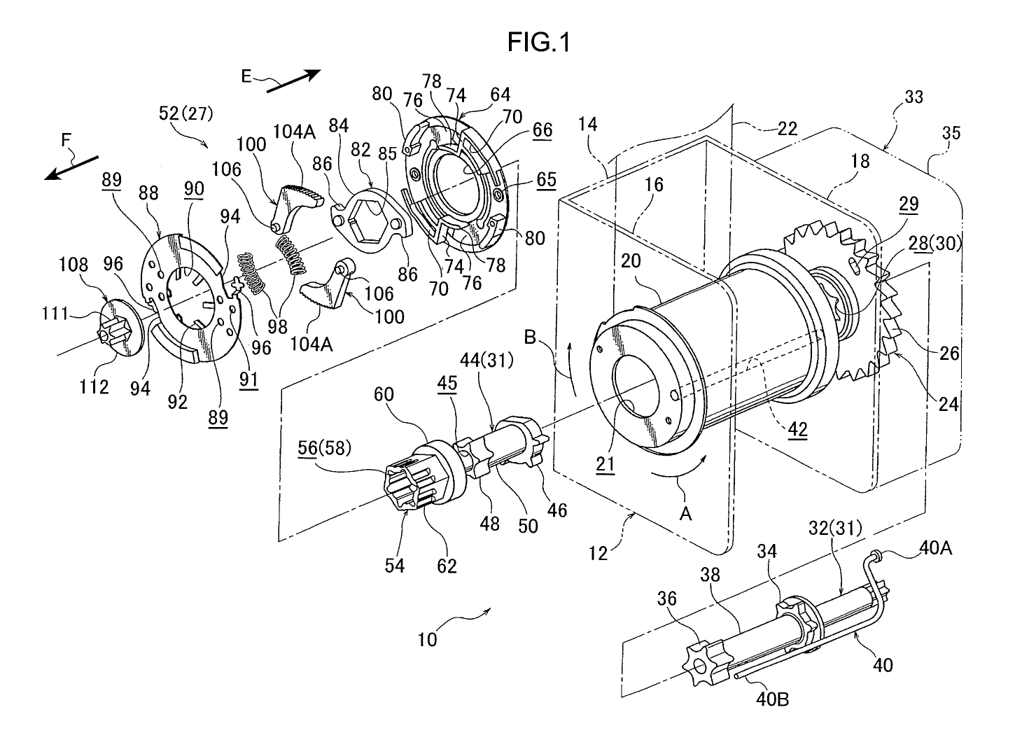

A webbing retractor 10 relating to a first embodiment of the present invention is described hereinafter by using FIG. 1 through FIG. 7.

As shown in FIG. 1 through FIG. 3, the webbing retractor 10 relating to the present first embodiment has a frame 12, a spool 20 that serves as a take-up shaft, a webbing 22, a lock gear 24, a main torsion shaft 32, a trigger wire 40, a sub torsion shaft 44 that serves as a torsion bar, a clutch mechanism 52, and a switching mechanism 120. The main torsion shaft 32 and the sub torsion shaft 44 structure a force limiter mechanism 31, and the clutch mechanism 52 and the switching mechanism 120 structure a rotation impeding mechanism 27.

As shown in FIG. 1, the frame 12 has a plate-shaped back plate 14 that is fixed to the vehicle body. Leg pieces 16, 18 extend substantially orthogonally from the vehicle transverse direction both end portions of the back plate 14, and the frame 12 is formed in a substantially concave shape as seen in plan view. Note that a known locking mechanism 33 is mounted to the outer side of the leg piece 18. Further, the webbing 22 is applied to the body of a passenger, and is formed in an elongated belt shape.

The spool 20 is formed in a cylindrical tube shape having a through-hole 21 that passes through in the axial direction, and is disposed between the leg piece 16 and the leg piece 18 of the frame 12. The spool 20 is disposed in a state in which the axial direction thereof is along the direction in which the leg piece 16 and the leg piece 18 oppose one another. The spool 20 is rotatably supported at the frame 12 via the main torsion shaft 32, the sub torsion shaft 44 and the like that are described later.

The webbing 22 is applied to the body of a passenger, and the proximal (base) end portion, that is a longitudinal direction one end portion thereof, is anchored on the spool 20. Due to the spool 20 rotating in a take-up direction (the direction of arrow A in FIG. 1 and the like) that is one rotating direction, the webbing 22 is taken-up and accommodated from the proximal end side thereof.

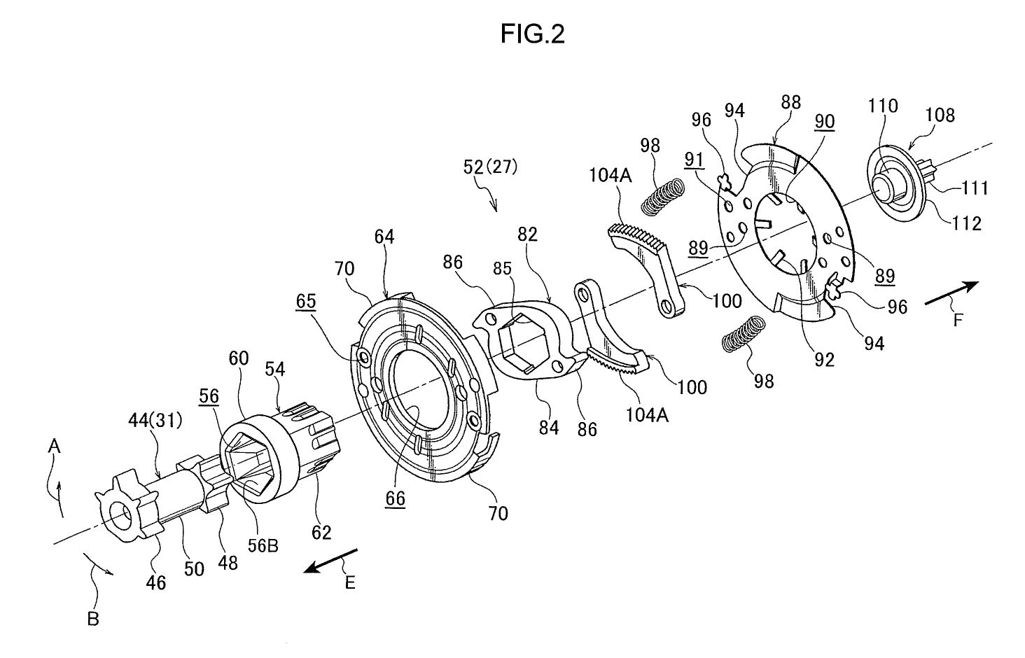

The lock gear 24 is disposed coaxially to the spool 20 at an axial direction one side of the spool 20 (the arrow E direction side in FIG. 1 and FIG. 2). A gear portion 26 is formed at the outer peripheral portion of the lock gear 24. Further, a through-hole 28, that passes through in the axial direction, is formed at the axially central portion of the lock gear 24. An anchor portion 30 that is spline-shaped is formed at the inner peripheral portion of the through-hole 28.

At the time of an emergency of the vehicle (a predetermined occasion such as rapid deceleration or the like), due to the aforementioned locking mechanism 35 detecting that the acceleration (in particular, the decelerating acceleration) of the vehicle is greater than or equal to a predetermined acceleration, or detecting that the pull-out acceleration of the webbing 22 from the spool 20 is greater than or equal to a specific acceleration, and operating, a locking member (not illustrated in the drawings) of the locking mechanism 35 engages with the gear portion 26 of the lock gear 24, and rotation of the lock gear 24 in the pull-out direction (the direction of arrow B in FIG. 1 and the like) is impeded (locked).

The main torsion shaft 32 is disposed coaxially with the spool 20 and the lock gear 24, and is inserted through the through-hole 21 of the spool 20 and the through-hole 28 of the lock gear 24, respectively. A first anchored portion 34 that is spline-shaped is formed at the longitudinal direction central portion of the main torsion shaft 32. A second anchored portion 36 that is similarly spline-shaped is formed at the distal end portion of the main torsion shaft 32.

Further, due to the first anchored portion 34 being fit-together with and anchored by the anchor portion 30 of the lock gear 24, the main torsion shaft 32 is connected to the lock gear 24 so as to be able to rotate integrally therewith. Further, due to the second anchored portion 36 being fit-together with and anchored by an unillustrated anchor portion that is formed at the axial direction intermediate portion of the inner peripheral portion of the spool 20, the main torsion shaft 32 is connected to the spool 20 so as to be able to rotate integrally therewith.

The proximal end portion of the main torsion shaft 32 (the end portion at the side opposite the second anchored portion 36) is rotatably supported at an unillustrated shaft-receiving hole that is formed in the sensor cover 35 (case) that is made of resin and that the locking mechanism 33 is provided with. The sensor cover 35 is mounted to the leg piece 18 of the frame 12. Due thereto, the axial direction one side of the spool 20 is rotatably supported at the frame 12 via the main torsion shaft 32 and the sensor cover 35.

The portion between the first anchored portion 34 and the second anchored portion 36 at the main torsion shaft 32 is structured as a first energy absorbing portion 38 that is for absorbing kinetic energy of the passenger that is used to pull the webbing 22 as is described later.

A proximal end portion 40A of the trigger wire 40 is inserted in a hole portion 29 that is formed at a position that is further toward the radial direction outer side than the through-hole 28 at the lock gear 24, and is anchored at the lock gear 24. On the other hand, the portion of the trigger wire 40 that is further toward the distal end side than the proximal end portion 40A thereof is inserted in a hole portion 42 that is formed in the spool 20 in parallel with the through-hole 21. A distal end portion 40B of the trigger wire 40 projects-out from the spool 20 toward the axial direction other side (the arrow F direction side in FIG. 1 and FIG. 2).

The sub torsion shaft 44 is disposed coaxially with the main torsion shaft 32. The portion of the sub torsion shaft 44 that is further toward the proximal end side than the longitudinal direction central portion thereof is inserted in the through-hole 21 of the spool 20. On the other hand, the portion of the sub torsion shaft 44 that is further toward the distal end side than the longitudinal direction central portion thereof projects-out from the spool 20 toward the axial direction other side.

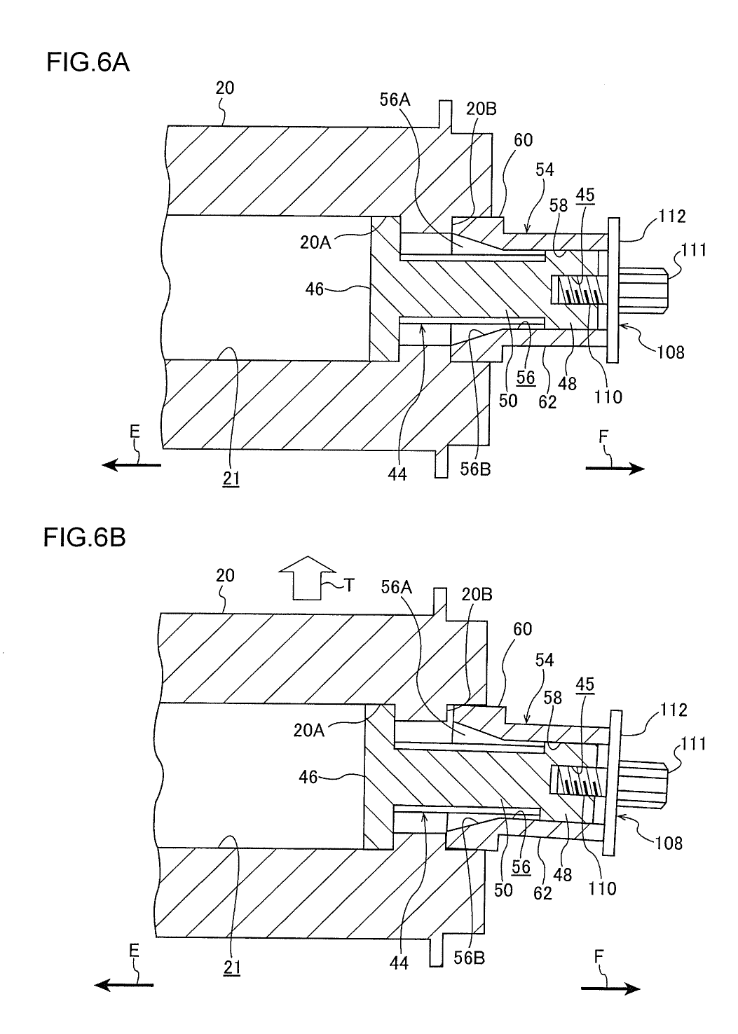

A first anchored portion 46 that is spline-shaped at least one portion thereof is formed at the proximal end portion (one end portion) of the sub torsion shaft 44. A second anchored portion 48 that is similarly spline-shaped is formed at the distal end portion (other end portion) of the sub torsion shaft 44. The first anchored portion 46 is fit-together with and anchored by an anchor portion 20A (refer to FIG. 6A) that is formed at the axial direction intermediate portion of the inner peripheral portion of the spool 20. Due thereto, the sub torsion shaft 44 is connected to the spool 20 so as to be able to rotate integrally therewith.

Further, the portion between the first anchored portion 46 and the second anchored portion 48 at the sub torsion shaft 44 is structured as a second energy absorbing portion 50 (torsionally deforming portion) for absorbing the kinetic energy of the passenger that is used to pull the webbing 22 as is described later.

(Structure of Clutch Mechanism 52)

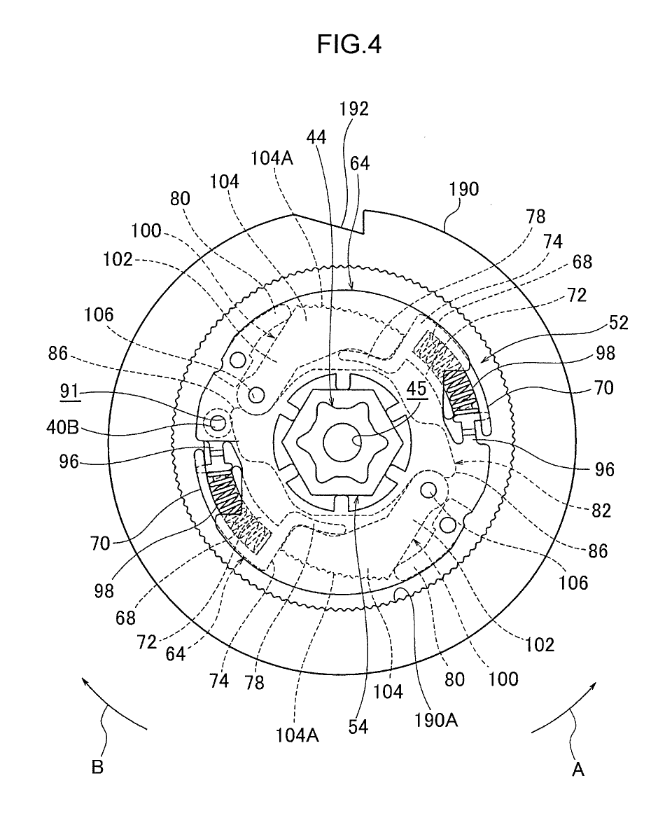

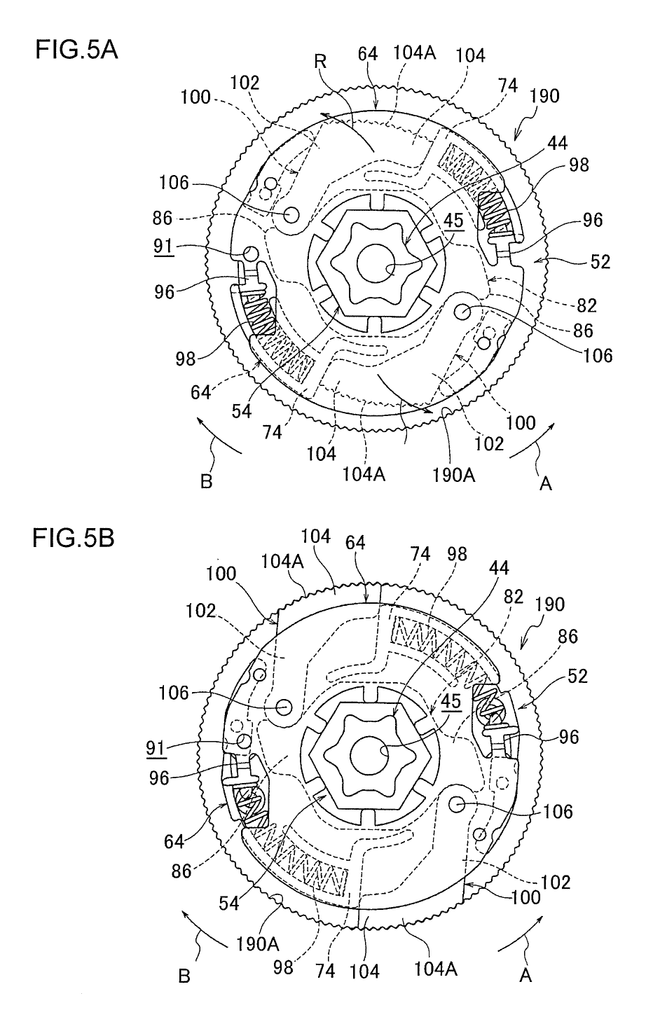

As shown in FIG. 1 and FIG. 2, the clutch mechanism 52 has a sleeve 54 that serves as a torsion bar anchoring member, a clutch guide 64, a clutch base 82, a clutch cover 88, a pair of clutch plates 100, a screw 108, and a pair of coil springs 98. Note that a non-operating state of the clutch mechanism 52 is shown in FIG. 4. A state in the midst of operation of the clutch mechanism 52 is shown in FIG. 5A, and a state after operation of the clutch mechanism 52 is completed is shown in FIG. 5B.

The sleeve 54 is formed by cold forging, and is disposed coaxially to the sub torsion shaft 44. An insert-through hole 56 that passes through in the axial direction is formed in the axially central portion of the sleeve 54. The second energy absorbing portion 50 of the above-described sub torsion shaft 44 is inserted-through (inserted with play in) the insert-through hole 56 in a state of non-contact. Further, an anchor portion 58 that is spline-shaped is formed at the distal end side (the arrow F direction side in FIG. 1 and FIG. 2) at the inner peripheral portion of the sleeve 54. Due to the second anchored portion 48 of the sub torsion shaft 44 being fit-together with and anchored by the anchor portion 58, the sleeve 54 is connected to the sub torsion shaft 44 so as to be able to rotate integrally therewith.

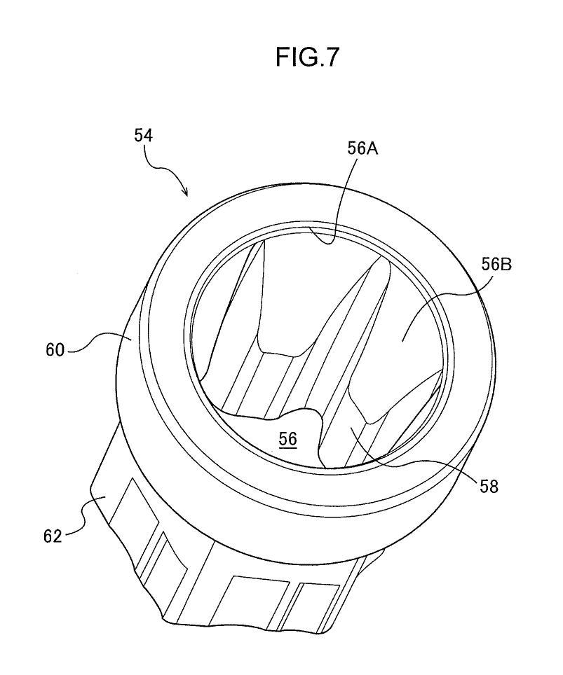

As shown in FIG. 6A and FIG. 7, an opening 56A side, that is at the side opposite the anchor portion 58, of the insert-through hole 56 of the sleeve 54 is made to be a tapered enlarged diameter portion 56B. At this tapered enlarged diameter portion 56B, the inner diameter of the insert-through hole 56 is enlarged in a tapered shaped toward the opening 56A (the proximal end side of the sleeve 54). Due thereto, the interval (distance) between the outer peripheral surface of the second energy absorbing portion 50 of the sub torsion shaft 44 and the inner peripheral surface of the insert-through hole 56 is structured so as to gradually increase toward the opening 56A. Note that, in the present embodiment, the length of the tapered enlarged diameter portion 56B along the axial direction of the sleeve 54 is set to be about ⅓ of the axial direction length of the sleeve 54. The tapered enlarged diameter portion 56B is formed simultaneously at the time when the sleeve 54 is formed by cold forging. Note that, in FIG. 6A and FIG. 6B, illustration of the main torsion shaft 32 and the like is omitted for easy viewing of the drawings.

Further, the proximal end side of the sleeve 54 is structured as a support portion 60 that has a cylindrical-tube-shaped outer peripheral surface. The supporting portion 60 is fit-together with the through-hole 21 of the spool 20 so as to rotate freely. A step portion 20B is formed such that the through-hole 21 is expanded in the form of a step at the axial direction other end side of the spool 20. Due to the supporting portion 60 (the proximal end portion of the sleeve 54) abutting this step portion 20B, relative displacement of the sleeve 54 toward the axial direction one side with respect to the spool 20 is restricted. Note that, in the present embodiment, the length of the supporting portion 60 along the axial direction of the sleeve 54 is set to be substantially equal to the length of the tapered enlarged diameter portion 56B along the axial direction of the sleeve 54 (around ⅓ of axial direction length of the sleeve 54).

Moreover, the portion of the sleeve 54 that is further toward the distal end side than the supporting portion 60 is structured as a press insertion (press-fit) portion 62 that is formed in a regular hexagonal shape in cross-section. This press-fit portion 62 is formed to have a smaller diameter than the supporting portion 60, and a step portion is formed between the press-fit portion 62 and the supporting portion 60. Namely, the outer diameter of the sleeve 54 at the proximal end side (the opening 56A side) is made to be large, and the inner periphery of this region where the outer diameter is made to be large (the supporting portion 60) is made to be the tapered enlarged diameter portion 56B.

The clutch guide 64 is made of resin, and is formed in an annular shape having a through-hole 66 that passes through in the axial direction. The above-described supporting portion 60 is inserted in this through-hole 66, and due thereto, the clutch guide 64 is supported at the sleeve 54 so as to be able to rotate relative thereto.

As shown in FIG. 4, a pair of coil spring accommodating portions 68, that accommodate the coil springs 98, are formed at positions at two places in the peripheral direction at the clutch guide 64. These coil spring accommodating portions 68 are formed in shapes having point symmetry around the central portion of the clutch guide 64. Each of the coil spring accommodating portions 68 is formed in a substantial U-shape having an outer side wall portion 70 and an inner side wall portion 72 that extend in the peripheral direction of the clutch guide 64, and a connecting wall portion 74 that extends in the radial direction of the clutch guide 64 and connects respective end portions of the outer side wall portion 70 and the inner side wall portion 72.

Further, a pair of clutch plate accommodating portions 76 that accommodate the clutch plates 100 are formed in the clutch guide 64 adjacent to the respective coil spring accommodating portions 68. A first supporting wall portion 78 that extends from the connecting wall portion 74 toward the side opposite the inner side wall portion 72, and a second supporting wall portion 80 that is apart from the connecting wall portion 74 at the side of the connecting wall portion 74 opposite the side at which the outer side wall portion 70 is located, are formed at these clutch plate accommodating portions 76.

The clutch base 82 is structured to have a base main body 84 that is annular. A press-fit hole 85 that is shaped as a regular hexagon in cross-section is formed in the base main body 84. The press-fit portion 62 of the above-described sleeve 54 is press-fit into this press-fit hole 85, and, due thereto, the clutch base 82 is fixed to the sleeve 54 so as to be able to rotate integrally therewith. Further, a pair of anchor portions 86 that project-out toward the outer side from the base main body 84 are formed at the clutch base 82. These anchor portions 86 are anchored on the proximal end portions of arm portions 102 that are formed at the clutch plates 100 that are described later.

The clutch cover 88 is disposed coaxially to the sleeve 54, and is disposed so as to face the clutch guide 64, at the side of the clutch guide 64 opposite the side at which the spool 20 is located. The clutch cover 88 is formed in an annular shape having a through-hole 90 that passes through in the axial direction. Plural fit-together claws 92, that project-out toward the radial direction inner side, are formed at the inner peripheral portion of the clutch cover 88. Further, due to the press-fit portion 62 of the sleeve 54 being inserted into the through-hole 90 and the plural fit-together claws 92 being fit-together with the press-fit portion 62, the clutch cover 88 is fixed to the sleeve 54, and accordingly to the sub torsion shaft 44, so as to be able to rotate integrally therewith. Further, cross-shaped claws 96, that are described later, of the clutch cover 88 engage with the clutch guide 64 in the peripheral direction, and the clutch guide 64 is made able to rotate relative to the clutch cover 88 between an operation position shown in FIG. 5B and a non-operation position shown in FIG. 4.

Cut-out portions 94, that are formed in concave shapes as seen in the axial direction and that open toward the radial direction outer side, are respectively formed at positions of two places in the peripheral direction at the clutch cover 88. Further, the pair of cross-shaped claws 96 are formed at the clutch cover 88 so as to be positioned at the inner sides of the respective cut-out portions 94. This pair of cross-shaped claws 96 is formed in shapes that are point symmetrical around the central portion of the clutch cover 88. Moreover, these cross-shaped claws 96 are bent in crank shapes as seen from the radial direction of the clutch cover 88, and the distal end sides thereof project-out further toward the clutch guide 64 side than the proximal end sides thereof.

An inner side projecting portion that projects-out toward the radial direction inner side of the clutch guide 64, an outer side projecting portion that projects-out toward the radial direction outer side of the clutch guide 64, and a peripheral direction projecting portion that projects-out in one peripheral direction of the clutch guide 64 (the take-up direction), are provided at the distal end sides of each of the cross-shaped claws 96. The distal end sides of each of the cross-shaped claws 96 are formed in the shape of a cross as seen from the axial direction of the clutch guide 64.

The clutch plates 100 (pawls) are disposed between the clutch cover 88 and the clutch guide 64. The clutch plates 100 have the arm portions 102, and arc-shaped portions 104 that are formed at the distal end portions of the arm portions 102. Rotating shafts 106, that project-out toward the clutch cover 88 side and extend along the axial direction of the sub torsion shaft 44, are formed at the proximal end portions of the arm portions 102. The clutch plates 100 are rotatably supported at the clutch cover 88 due to the rotating shafts 106 being inserted in hole portions 89 that are formed in the clutch cover 88. Further, flat-tooth-shaped knurled teeth 104A are formed at the outer peripheral portions of the arc-shaped portions 104 (the distal end portions of the clutch plates 100).

As shown in FIG. 1 and FIG. 2, the screw 108 has a screw portion 110, and a pushing portion 112 that has a larger diameter than the screw portion 110. As shown in FIG. 6A, the screw portion 110 is screwed-together with a screw hole 45 that is formed in the distal end portion of the sub torsion shaft 44. Due thereto, the screw 108 is fixed to the distal end portion of the sub torsion shaft 44. Further, in the state in which the screw 108 is fixed to the distal end portion of the sub torsion shaft 44 in this way, the pushing portion 112 abuts the distal end portion of the sleeve 54. Due thereto, movement of the sleeve 54 in the direction of coming-off from the sub torsion shaft 44 (the arrow F direction) is limited, and the sleeve 52 is pushed against the step portion 20B of the spool 20 by the pushing portion 112 of the screw 108. Therefore, the sleeve 54 is mounted without play (backlash) to the spool 20. Further, in this state, axial direction movement of the clutch guide 64 is limited by the clutch cover 88 and the spool 20. (Note that, in FIG. 6A and FIG. 6B, illustration of members other than the sleeve 54 and the screw 108 among the structural members of the clutch mechanism 52 is omitted.)

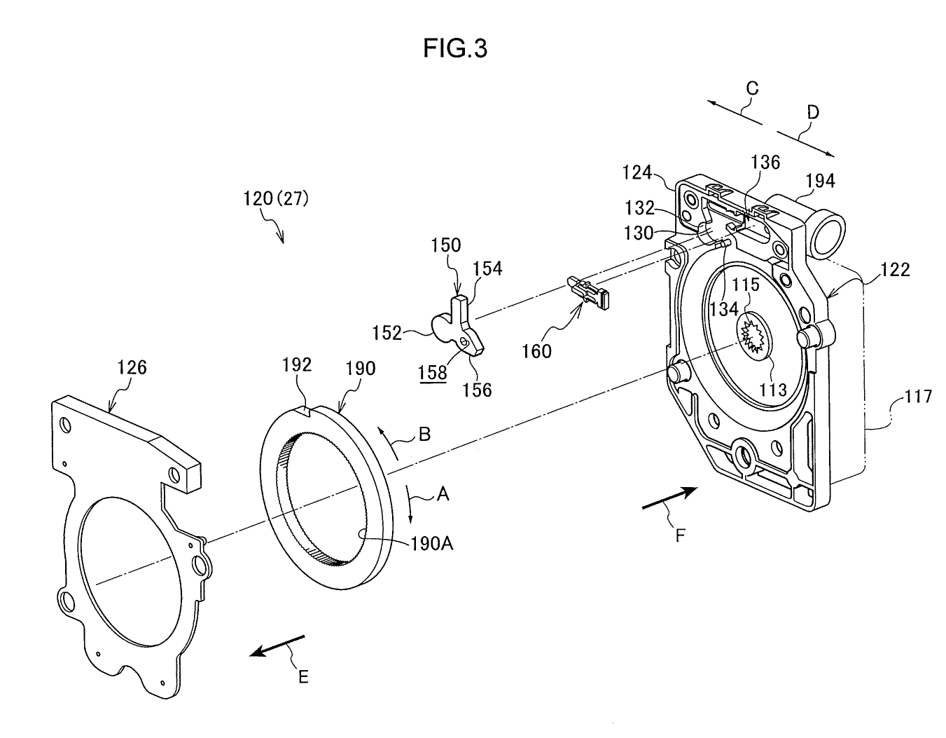

Further, a connecting portion 111 that is spline-shaped is provided at the screw 108 at the side of the pushing portion 112 opposite the side at which the screw portion 110 is located. This connecting portion 111 is provided coaxially to the screw portion 110. The connecting portion 111 is fit into a connecting hole 115 of an adapter 113 that is disposed at the side of the switching mechanism 120 (see FIG. 3) that is described later, which side is opposite the side at which the leg piece 16 of the frame 12 is located. The adapter 113 is rotatably supported at a spring cover 117 that is made of resin. The spring cover 117 is mounted to the leg piece 16 of the frame 12 via a body 122 of the switching mechanism 120. Due thereto, the axial direction other side of the spool 20 is rotatably supported at the frame 12 via the sub torsion shaft 44, the sleeve 54, the screw 108, the adapter 113, the spring cover 117 and the body 122. Note that the other end portion of an unillustrated spiral spring, whose one end portion is anchored on the spring cover 117, is anchored on the above-described adapter 113, and the spool 20 is urged in the take-up direction by this spiral spring.

Further, hole portions 65, 91 are formed in the above-described clutch guide 64 and clutch cover 88, respectively. These hole portions 65, 91 are formed so as to face one another in the state in which the clutch guide 64 is disposed at the non-operation position with respect to the clutch cover 88. The distal end portion 40B of the trigger wire 40 is inserted respectively into these hole portions 65, 91. Due thereto, in the state in which the clutch guide 64 is disposed at the non-operation position, relative rotation of the clutch guide 64 with respect to the spool 20 and the clutch cover 88 is limited (the clutch guide 64 is restrained at the non-operation position).

Still further, in the state in which the clutch guide 64 is restrained at the non-operation position as described above, the respective cross-shaped claws 96 of the clutch cover 88 are disposed in vicinities of the opening portions at the respective coil spring accommodating portions 68 of the clutch guide 64. Further, the peripheral direction projecting portions of the respective cross-shaped claws 96 are inserted into the inner sides of the coil springs 98 from axial direction one end portions of the coil springs 98 that are accommodated in the respective coil spring accommodating portions 68. The inner side projecting portions and the outer side projecting portions of the respective cross-shaped claws 96 abut the axial direction one end portions of the coil springs 98. Due thereto, the axial direction one end portions of the coil springs 98 are anchored on the respective cross-shaped claws 96. Further, the axial direction other end portions of the coil springs 98 are anchored on the connecting wall portions 74 (see FIG. 4) of the coil spring accommodating portions 68.

In this state, the intervals between the cross-shaped claws 96 and the connecting wall portions 74 are shorter than the full lengths in the free states of the coil springs 98, and, due thereto, the coil springs 98 are in compressed states. Further, due thereto, urging force in the take-up direction is imparted to the clutch guide 64, and the clutch guide 64 is urged toward the operation position.

On the other hand, in this state, there is a state in which the intervals between the hole portions 89 of the clutch cover 88 (the rotating shafts 106 of the clutch plates 100) and the connecting wall portions 74 are sufficiently ensured, and the clutch plates 100 are accommodated in the clutch plate accommodating portions 76 such that the knurled teeth 104A are kept further toward the inner side than the outer peripheral portion of the clutch guide 64. Further, in this state, the connecting wall portions 74 abut the distal ends of the arc-shaped portions 104.

(Structure of Switching Mechanism 120)

As shown in FIG. 3, the switching mechanism 120 has the body 122 that is box shaped. The interior of the body 122 is open toward the leg piece 16 side of the frame 12, and the body 122 is fixed to the outer side of the leg piece 16. A lock ring 190 (link portion) that is substantially annular plate shaped is supported so as to rotate freely at the interior of the body 122. The lock ring 190 is disposed coaxially to the clutch mechanism 52, at the outer peripheral side of the clutch mechanism 52. Further, flat-tooth-shaped knurled teeth 190A are formed at the inner peripheral portion of the lock ring 190. Moreover, a lock hole 192, that is substantially triangular in cross-section, is formed to pass through the outer peripheral portion of the lock ring 190. The lock hole 192 opens toward the radial direction outer side of the lock ring 190.

A case portion 124, that serves as a housing portion that houses a pawl 150, a piston 160, and a gas generator 194 that are described later, is provided at the upper portion of the body 122. Further, a substantially plate-shaped sheet 126 is provided at the leg piece 16 side of the body 122, and the sheet 126 closes-off the opening portion of the body 122.

A concave portion 130 that opens toward the leg piece 16 side is provided at the case portion 124. A supporting portion 132, that is substantially C-shaped in cross-section, is formed at the concave portion 130. The supporting portion 132 supports a shaft portion 152 of the pawl 150, that is described later, so as to rotate freely. Further, a shear pin 134 that is solid cylindrical is provided integrally with the case portion 124 at the interior of the concave portion 130, and the shear pin 134 projects-out toward the leg piece 16 side. A piston accommodating portion 136 is provided within the concave portion 130. The piston 160, that is manufactured of resin, is accommodated within the piston accommodating portion 136 so as to be able to move rectilinearly in the longitudinal direction of the piston accommodating portion 136 (the arrow C direction and the arrow D direction in FIG. 3).

The pawl 150 that is substantially plate-shaped is accommodated within the concave portion 130 of the case portion 124. The shaft portion 152, that is substantially circular in cross-section, is provided at the pawl 150 at the portion thereof at the supporting portion 132 side of the concave portion 130, and the shaft portion 152 is supported at the supporting portion 132 so as to rotate freely. Further, the pawl 150 has a substantially L-shaped arm portion 154. An engaging portion 156 is provided at the proximal end portion of the arm portion 154. The distal end of the engaging portion 156 is disposed within the lock hole 192 of the lock ring 190 (at a locking position), and is engaged with the lock ring 190. Moreover, an anchor hole 158, that is circular in cross-section, is formed so as to pass through the proximal end portion of the arm portion 154. The aforementioned shear pin 134 is inserted through the anchor hole 158 interior, and rotation of the pawl 150 is limited. Further, the gas generator 194, that is substantially solid cylindrical, is incorporated within the case portion 124 at a region that is at the side of the piston accommodating portion 136 opposite the side at which the leg piece 16 is located. The gas generator 194 communicates with the piston accommodating portion 136. The control device (not illustrated in the drawings) of the vehicle is electrically connected to this gas generator 194. At the time when the gas generator 194 is operated due to control of the control device, the gas generator 194 generates gas, and this gas is supplied to a cylinder portion 140 of the piston accommodating portion 136.

The aforementioned control device is electrically connected to a collision detection unit that is not illustrated in the drawings. The collision detection unit predicts a collision of the vehicle by, for example, an acceleration sensor that senses the acceleration (a sudden deceleration in particular) of the vehicle, or a distance measuring sensor that detects the distance to an obstacle in front of the vehicle, or the like. Further, the collision detection unit is structured so as to detect that the vehicle has collided, due to the acceleration sensor sensing a collision acceleration that is greater than or equal to a predetermined reference value.

Moreover, the control device is electrically connected to a physique detection unit that is not illustrated in the drawings. The physique detection unit detects the physique of the passenger seated in the seat by, for example, a load sensor, a belt sensor, a seat position sensor, or the like. Concretely, a load sensor detects the load that is applied to a seat of the vehicle, and the physique detection unit detects the physique of the passenger in accordance with the detected load. Further, a belt sensor detects the amount of the webbing 22 that is pulled-out from the spool 20, and the physique detection unit detects the physique of the passenger in accordance with the detected pulled-out amount. Moreover, a seat position sensor is structured by a position detection sensor that detects the slid position of the vehicle seat in the front-back direction, or by a camera sensor that is provided in the vehicle cabin, and the physique detection unit detects the physique of the passenger in accordance with the position of the seat detected by the seat position sensor.

The gas generator 194 is operated by the control device in a case in which the control device judges, on the basis of a signal from the physique detection unit, that the physique of the passenger is less than a predetermined reference value, and judges, on the basis of a signal from the collision detection unit, that the vehicle has collided. Due thereto, gas is supplied from the gas generator 194 to the interior of the piston accommodating portion 136. When gas is supplied to the interior of the piston accommodating portion 136, due to the pressure of this gas, the piston 160 moves toward the arm portion 154 side of the pawl 150. Due thereto, the piston 160 pushes the arm portion 154, and rotational force is thereby applied to the pawl 150. Due to the pawl 150 rotating toward a lock releasing position while breaking the shear pin 134 due to this rotational force, the engaging portion 156 of the pawl 150 is pulled-out from the lock hole 192 of the lock ring 190. Note that due to an elastic hook, that is provided at the outer peripheral portion of the piston 160, catching on a step portion that is formed at the inner peripheral portion of the piston accommodating portion 136, movement of the piston 160, that has moved toward the arm portion 154 side, toward the side opposite the arm portion 154 is restricted.

(Operation)

The operation and effects of the present first embodiment are described next.

In the webbing retractor of the above-described structure, the spool 20, the lock gear 24, the main torsion shaft 32, the sub torsion shaft 44 and the clutch mechanism 52 (including the sleeve 54, the clutch base 82, the clutch plates 100 and the screw 108) are able to rotate integrally in the take-up direction and the pull-out direction.

Due to the webbing 22 being pulled-out from the spool 20, the webbing 22 is applied to the body of a passenger of the vehicle. In the state in which the webbing 22 is applied to the body of a passenger of the vehicle, when, for example, the vehicle enters into a state of rapid deceleration and the locking mechanism 33 operates, rotation of the lock gear 24 in the pull-out direction is impeded.

Due thereto, rotation, in the pull-out direction, of the spool 20 that is connected to the lock gear 24 via the main torsion shaft 32 is limited, and pulling-out of the webbing 22 from the spool 20 is limited. Accordingly, due thereto, the body of the passenger, that starts to move toward the vehicle front, is restrained by the webbing 22.

In the state in which rotation, in the pull-out direction, of the lock gear 24 is impeded, when the body of the passenger pulls the webbing 22 by an even greater force, and the rotational force of the spool 20 in the pull-out direction, that is based on this pulling force, exceeds the twist resisting load (the deformation resisting load) of the first energy absorbing portion 38 of the main torsion shaft 32, the force limiter mechanism 31 is operated. Due to the twisting (deformation) of the first energy absorbing portion 38, rotation, in the pull-out direction and that is greater than or equal to the force limiter load (the twist resisting load of the first energy absorbing portion 38), of the spool 20 is permitted.

Accordingly, due to the twisting of the first energy absorbing portion 38, the spool 20 is rotated in the pull-out direction, and the webbing 22 is pulled-out from the spool 20. Due thereto, the load (burden) on the chest portion of the passenger due to the webbing 22 is reduced, and the kinetic energy of the passenger, that is used to pull the webbing 22, is absorbed by an amount corresponding to the amount of twisting of the first energy absorbing portion 38.

On the other hand, as described above, the spool 20 being rotated in the pull-out direction with respect to the lock gear 24 means that the lock gear 24 is rotated in the take-up direction relative to the spool 20. Accordingly, when the lock gear 24 is rotated relative to the spool 20 in the take-up direction, the proximal end portion 40A of the trigger wire 40 is moved in the peripheral direction of the main torsion shaft 32 while the portion of the trigger wire 40, which portion is further toward the distal end side than the proximal end portion 40A, remains inserted in the hole portion 42 of the spool 20. Therefore, the portion of the trigger wire 40, which portion is further toward the distal end side than the proximal end portion 40A, is pulled toward the lock gear 24 side with respect to the hole portion 42.

Due thereto, the distal end portion 40B of the trigger wire 40 is pulled-out from the hole portion 65 of the clutch guide 64 and the hole portion 91 of the clutch cover 88, and the state, in which relative rotation of the clutch guide 64 with respect to the spool 20 and the clutch cover 88 is impeded, is cancelled.

Then, when the clutch guide 64 is rotated from the non operation position to the operation position due to the urging forces of the coil springs 98, the intervals between the hole portions 89 of the clutch cover 88 (the rotating shafts 106 of the clutch plates 100) and the connecting wall portions 74 of the clutch guide 64 become short, and the distal ends of the arc-shaped portions 104 of the clutch plates 100 are pushed (guided) in tangent directions of the clutch guide 64 by the connecting wall portions 74. Due thereto, the clutch plates 100 are rotated toward the lock ring 190 side (refer to arrow R in FIG. 5A), and the knurled teeth 104A of the clutch plates 100 mesh-together with the knurled teeth 190A of the lock ring 190 (the state shown in FIG. 5B). Due thereto, the clutch plates 100 and the lock ring 190 are joined. Further, at this time, due to the anchor portions 86, that are formed at the clutch base 82, pushing the proximal end portions of the arm portions 102 of the clutch plates 100 in the pull-out direction, the clutch plates 100 are pushed against the lock ring 190, and the state in which the clutch plates 100 and the lock ring 190 are joined is maintained. Due thereto, the lock ring 190 attempts to rotate in the pull-out direction integrally with the rotation in the pull-out direction of the clutch mechanism 52 (the sleeve 54, the clutch base 82, and the clutch plates 100).

Further, on the basis of a signal from the physique detection unit, the control device judges whether or not the physique of the passenger is greater than or equal to a predetermined reference value, and, on the basis of a signal from the collision detection unit, the control device judges whether or not the vehicle has collided. When the control devices judges that the physique of the passenger is greater than or equal to the predetermined reference value, the gas generator 194 is not operated, and therefore, the engaging portion 156 of the pawl 150 is disposed at the locking position and is engaged with the lock hole 192 of the lock ring 190. Thus, rotation of the lock ring 190 in the pull-out direction is locked (impeded), and due thereto, rotation of the clutch mechanism 52 (the sleeve 54, the clutch base 82 and the clutch plates 100) in the pull-out direction is impeded.

Further, in the state in which rotation, in the pull-out direction, of the sleeve 54, i.e., the other end portion of the sub torsion shaft 44 (the second anchored portion 48), is impeded, when the body of the passenger pulls the webbing with even greater force, and the rotational force of the spool 20 in the pull-out direction that is based on this pulling force exceeds the total of the twist resisting load (the deformation resisting load) of the first energy absorbing portion 38 of the main torsion shaft 32 and the twist resisting load (the deformation resisting load) of the second energy absorbing portion 50 of the sub torsion shaft 44, due to the twisting (deformation) of the first energy absorbing portion 38 and the second energy absorbing portion 50, rotation, in the pull-out direction and that is greater than or equal to the force limiter load (the total of the twist resisting load of the first energy absorbing portion 38 and the twist resisting load of the second energy absorbing portion 50), of the spool 20 is permitted.

Accordingly, due to the spool 20 being rotated in the pull-out direction by the twisting the first energy absorbing portion 38 and the second energy absorbing portion 50, and the webbing 22 being pulled-out from the spool 20, the load (burden) on the chest portion of the passenger due to the webbing 22 is reduced, and the kinetic energy of the passenger, that is used to pull the webbing 22, is absorbed by an amount corresponding to the amounts of twisting of the first energy absorbing portion 38 and the second energy absorbing portion 50.

On the other hand, when the control device judges, on the basis of a signal from the physique detection unit, that the physique of the passenger is less than the predetermined reference value, and judges, on the basis of a signal from the collision detection unit, that the vehicle has collided, the gas generator 194 is operated by control of the control device.

When the gas generator 194 is operated, gas is supplied from the gas generator 194 into the cylinder portion 140 of the piston accommodating portion 136. When gas is supplied into the cylinder portion 140, the piston 160 moves toward the arm portion 154 side of the pawl 150 and pushes the arm portion 154. Therefore, rotational force around the shaft portion 152 is applied to the pawl 150. Due to this rotational force, the inner peripheral portion of the anchor hole 158 of the pawl 150 abuts the shear pin 134 and breaks the shear pin 134, and due thereto, rotation of the pawl 150 around the shaft portion 152 is permitted, and the pawl 150 is rotated from the locking position to the releasing position. Due thereto, the engaging portion 156 of the pawl 150 moves away from the lock hole 192 of the lock ring 190, and rotation of the lock ring 190 in the pull-out direction is permitted. Due thereto, the lock ring 190 is made able to rotate in the pull-out direction together with the clutch mechanism 52 (the sleeve 54, the clutch base 82 and the clutch plates 100) and the spool 20. Therefore, twisting does not arise at the second energy absorbing portion 50, and thus, due to the twisting (deformation) of the first energy absorbing portion 38, rotation, in the pull-out direction and of greater than or equal to the force limiter load (the twist resisting load of the first energy absorbing portion 38), of the spool 20 is permitted.

Namely, when the physique of the passenger is greater than or equal to the predetermined reference value, the force limiter load is made to be the total of the twist resisting load of the first energy absorbing portion 38 and the twist resisting load of the second energy absorbing portion 50, and the load value of the force limiter load is made to be a high load. On the other hand, when the physique of the passenger is less than the predetermined reference value and collision of the vehicle is detected, the force limiter load is made to be the twist resisting load of the first energy absorbing portion 38, and the load value of the force limiter load is made to be a low load. Therefore, the passenger can be protected appropriately in accordance with his/her physique.

Here, in the present embodiment, in the state in which rotation, in the pull-out direction, of the other end portion of the sub torsion shaft 44 (the second anchored portion 48) is impeded, i.e., in the state in which the second anchored portion 48 of the sub torsion shaft 44 is connected to the frame 12 via the rotation impeding mechanism 27 (the clutch mechanism 52 and the switching mechanism 120), when the spool 20 is pulled by excessive tension that is applied to the webbing 22, there is the possibility that the spool 20 will tilt with respect to the sleeve 54 that is supported at the frame 12 via the rotation impeding mechanism 27.

Namely, the sleeve 54 is usually mounted to the spool 20 without play, but, when the length of the second energy absorbing portion 50 of the sub torsion shaft 44 increases slightly due to the second energy absorbing portion 50 torsionally deforming, there may be a case in which a slight gap arises between the supporting portion 60 of the sleeve 54 and the step portion 20B of the spool 20. Therefore, as shown in FIG. 6B, there is the possibility that the spool 20 will tilt with respect to the sleeve 54 due to pulling force T from the webbing 22. In this case, the distance between the second energy absorbing portion 50 of the sub torsion shaft 44 and the inner peripheral surface of the insert-through hole 56 changes. This change in distance is large at the opening 56A side of the insert-through hole 56, but the inner diameter of the insert-through hole 56 is enlarged at the opening 56A side. Due thereto, it is possible to make it such that the second energy absorbing portion 50 of the sub torsion shaft 44 does not interfere with the inner peripheral surface of the insert-through hole 56 of the sleeve 54.

In other words, even in a case in which the length of the second energy absorbing portion 50 disposed within the insert-through hole 56 becomes long by setting the length of the sub torsion shaft 44 to be long, interference between the second energy absorbing portion 50 and the inner peripheral surface of the insert-through hole 56 can be prevented by the tapered enlarged diameter portion 56B of the sleeve 54. Due thereto, the number of times of torsion (number of times of twisting) of the sub torsion shaft 44 can be increased. Further, because the diameter of the second energy absorbing portion 50 can be made to be large, a high torsional torque can be obtained.

Moreover, in the present embodiment, the inner diameter of the insert-through hole 56 of the sleeve 54 is enlarged in a tapered shape toward the opening 56A side of the insert-through hole 56. Due thereto, the rigidity of the sleeve 54 can be ensured while interference between the second energy absorbing portion 50 of the sub torsion shaft 44 and the inner peripheral surface of the insert-through hole 56 is prevented well. Namely, in a case in which the inner diameter of the insert-through hole 56 is enlarged in a stepped form, there is the possibility that stress will concentrate at the step portion. However, in the present embodiment, concentration of stress such as that described above can be avoided due to the tapered enlarged diameter portion 56B.

Further, in the present embodiment, the sleeve 54, at which the inner diameter of the insert-through hole 56 is enlarged in a tapered shape at the opening 56A side, is formed (molded) by forging. Therefore, a cutting process for enlarging the inner diameter of the insert-through hole 56 in a tapered shape is not needed. Due thereto, a decrease in the cost of the sleeve 54 can be achieved.

Moreover, in the present embodiment, at the sleeve 54, the opening 56A side is made to be the supporting portion 60 at which the outer diameter is greater than that of the press-fit portion 62, and, at the side where the inner diameter of the insert-through hole 56 is enlarged, the outer diameter is enlarged. Due thereto, the angle of inclination of the tapered enlarged diameter portion 56B can be set to be large, while ensuring the rigidity of the sleeve 54 at the side where the inner diameter of the insert-through hole 56 is enlarged. Therefore, interference between the torsionally deforming portion 50 and the inner peripheral surface of the insert-through hole 56 can be prevented well.

Another embodiment of the present invention is described next. Note that structures and operations that are basically similar to those of the above-described first embodiment are denoted by the same reference numerals as in the first embodiment, and description thereof is omitted.

### Second Embodiment

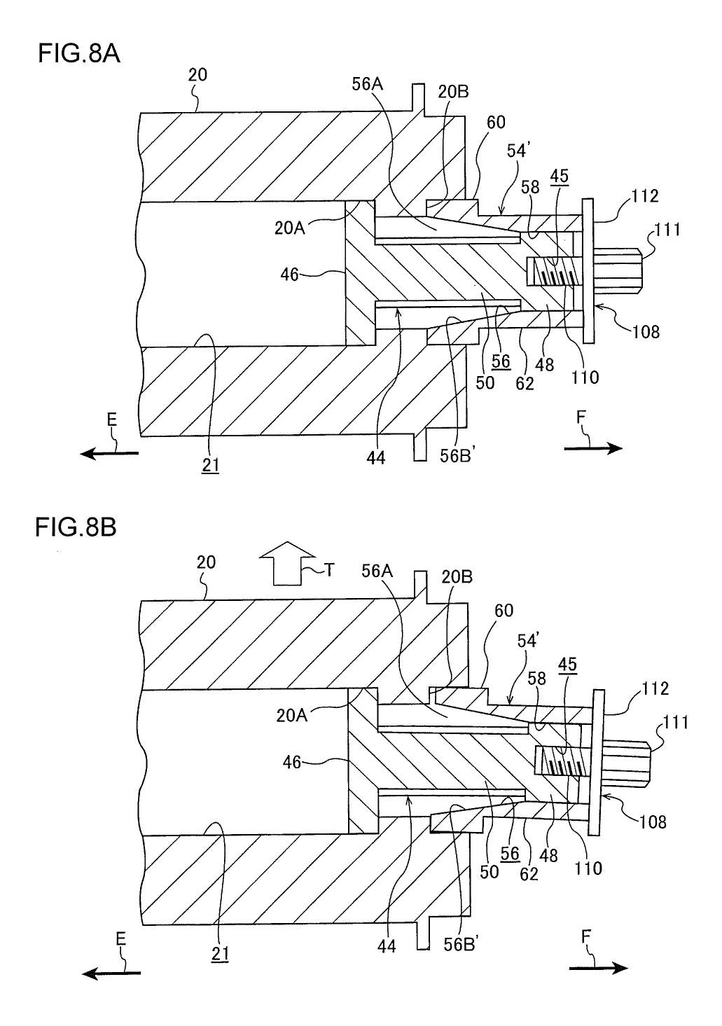

The partial structure of a webbing retractor relating to a second embodiment of the present invention is shown in cross-sectional views in FIG. 8A and FIG. 8B. In this embodiment, the structure of a sleeve 54′ is slightly different than that of the sleeve 54 relating to the above-described first embodiment. This sleeve 54′ has a structure that is basically similar to that of the sleeve 54, but the entire region of the sleeve 54′ between the anchor portion 58 and the opening 56A (preferably, between the opening 56A side end (or the vicinity thereof) of the anchor portion 58 and the opening 56A) is made to be enlarged diameter portion, preferably, to be a tapered enlarged diameter portion 56B′. The length of the tapered enlarged diameter portion 56B′ along the axial direction of the sleeve 54′ is set to be larger than that of the tapered enlarged diameter portion 56B relating to the above-described first embodiment.

### Supplementary Description of the Embodiments

The above-described respective embodiments describe cases in which the present invention is applied to the sleeve 54, 54′ (torsion bar anchoring member) at which the second anchored portion 48 (other end portion) of the sub torsion shaft 44 (torsion bar) is anchored. However, the present invention is not limited to the same, and may be applied to the retainer (torsion bar anchoring member) disclosed in JP-A No. 11-105671 that is described in the Related Art. In this case, the locking base, at which the other end portion of the torsion bar in that publication is anchored, and the emergency locking unit are made to be the rotation impeding mechanism.

Further, the above-described respective embodiments are structured such that the outer diameter of the sleeve 54, 54′ (torsion bar anchoring member) is enlarged at the opening 56A side. However, the present invention is not limited to the same, and the shape of the torsion bar anchoring member can be changed appropriately.

Further, although the above-described respective embodiments are structured such that the inner diameter of the insert-through hole 56 is enlarged in a tapered shape toward the opening 56, the present invention is not limited to the same, and may be structured such that the inner diameter of the insert-through hole is enlarged in a stepped form toward the opening (for example, having a single step portion or plural step portions that are enlarged gradually toward the opening).

In addition, the present invention can be implemented by changed in various ways within a scope that does not deviate from the gist thereof Further, the scope of the right of the present invention is, of course, not limited to the above-described embodiments.

What is claimed is:

1. A webbing retractor comprising:
a take-up shaft that is rotatably supported at a frame, and that takes-up a webbing for restraining a passenger;
a torsion bar, one end portion of which is connected to the take-up shaft so as to be unable to rotate relative to the take-up shaft, the torsion bar comprising a torsionally deforming portion, that is provided at an intermediate portion of the torsion bar, torsionally deforming when tension of a set value or more is applied to the webbing in a state in which another end portion of the torsion bar is connected to the frame via a rotation impeding mechanism; and
a torsion bar anchoring member that is rotatably supported at the frame, and that includes
an anchor portion at which the one end portion or the other end portion of the torsion bar is anchored, and
an insert-through hole including an opening that is open at a side of the torsion bar anchoring member opposite a side at which the anchor portion is provided, through which the torsionally deforming portion is inserted in a state of not contacting an inner side of the insert-through hole, an inner diameter of the insert-through hole being enlarged at the opening side.

2. The webbing retractor of claim 1, wherein the inner diameter of the insert-through hole is enlarged in a tapered shape toward the opening

3. The webbing retractor of claim 1, wherein an outer diameter of the torsion bar anchoring member is enlarged at the opening side.

4. The webbing retractor of claim 2, wherein an outer diameter of the torsion bar anchoring member is enlarged at the opening side.

5. The webbing retractor of claim 1, wherein
the torsion bar anchoring member is a structural member of the rotation impeding mechanism, and is mounted to the take-up shaft so as to be able to rotate relative to the take-up shaft, and the other end portion of the torsion bar is anchored at the anchor portion, and
the rotation impeding mechanism is structured so as to, by connecting the torsion bar anchoring member and the frame, impede rotation of the torsion bar anchoring member in a webbing pull-out direction.

6. The webbing retractor of claim 2, wherein
the torsion bar anchoring member is a structural member of the rotation impeding mechanism, and is mounted to the take-up shaft so as to be able to rotate relative to the take-up shaft, and the other end portion of the torsion bar is anchored at the anchor portion, and
the rotation impeding mechanism is structured so as to, by connecting the torsion bar anchoring member and the frame, impede rotation of the torsion bar anchoring member in a webbing pull-out direction.

7. The webbing retractor of claim 3, wherein
the torsion bar anchoring member is a structural member of the rotation impeding mechanism, and is mounted to the take-up shaft so as to be able to rotate relative to the take-up shaft, and the other end portion of the torsion bar is anchored at the anchor portion, and
the rotation impeding mechanism is structured so as to, by connecting the torsion bar anchoring member and the frame, impede rotation of the torsion bar anchoring member in a webbing pull-out direction.

8. The webbing retractor of claim 3, wherein a length along an axial direction of a portion of the torsion bar anchoring member, at which the outer diameter is enlarged at the opening side, is substantially the same as a length along the axial direction of a portion of the torsion bar anchoring member, at which the inner diameter of the insert-through hole is enlarged at the opening side.

9. The webbing retractor of claim 4, wherein a length along an axial direction of a portion of the torsion bar anchoring member, at which the outer diameter is enlarged at the opening side, is substantially the same as a length along the axial direction of a portion of the torsion bar anchoring member, at which the inner diameter of the insert-through hole is enlarged in the tapered shape toward the opening.

10. The webbing retractor of claim 1, wherein
the other end portion of the torsion bar is anchored at the anchor portion of the torsion bar anchoring member, and
the inner diameter of the insert-through hole is enlarged between the opening and the anchor portion.

11. The webbing retractor of claim 10, wherein the inner diameter of the insert-through hole is enlarged in a tapered shape toward the opening from the anchor portion.

12. The webbing retractor of claim 3, wherein a length along an axial direction of a portion of the torsion bar anchoring member, which is fit with the take-up shaft so as to rotate freely, is substantially the same as a length along the axial direction of a portion of the torsion bar anchoring member, at which the inner diameter of the insert-through hole is enlarged at the opening side.
